(19) United States
(12) Patent Application Publication
(10) Pub. No.: US 2005/0273512 A1
(43) Pub. Date: Dec. 8, 2005

(54) Method for reestablishing session of client in mobile terminal

(75) Inventor: Song-Rae Cho, Gyeonggi-Do (KR)

Correspondence Address: JONATHAN Y. KANG, ESQ.;LEE, HONG, DEGERMAN, KANG & SCHMADEKA, P.C., 14th Floor, 801 S. Figueroa Street, Los Angeles, CA, 90017, US

(73) Assignee: LG Electronics Inc.

(21) Appl. No.: 11/147,679

(22) Filed: Jun. 7, 2005

Related U.S. Application Data
(60) Provisional application No. 60/577,583, filed on Jun. 8, 2004.

(30) Foreign Application Priority Data
Apr. 22, 2005 (KR) 2005-33769

(51) Int. Cl. G06F 15/16; H04M 3/00

(52) U.S. Cl. 709/228; 455/419

(57) ABSTRACT

The present invention relates to a method for reestablishing a client session in a mobile terminal. When an IMPS client session loaded onto a mobile terminal is opened, the IMPS client stores session information in a memory of the mobile terminal. When power of the mobile terminal is turned off and then turned on, the IMPS client checks whether the session is effective or not through a Keep Alive transaction. The IMPS client then restores the session using the information stored in the memory if the session is effective. Preferably, the memory is nonvolatile memory, and information of the session comprises contact lists information, contacts information, a session ID for checking a session and the like.

### CROSS-REFERENCE TO RELATED APPLICATIONS

Pursuant to 35 U.S.C. § 119, this application claims the benefit of earlier filing date and right of priority to Korean Application No. 2005-33769, filed on Apr. 22, 2005, and U.S. Provisional Application No. 60/577,583, filed on Jun. 7, 2004, the contents of which are hereby incorporated by reference herein in their entirety.

### FIELD OF THE INVENTION

The present invention relates to instant messaging and presence services in a wireless communication system, and more particularly, to reestablishing a client session in a mobile terminal.

### BACKGROUND OF THE INVENTION

Instant Messaging and Presence Services (IMPS) are new techniques related to a new communication device based on the Internet. IMPS are used to exchange message and presence information between a mobile device, a mobile communication service and an Internet-based instant messaging service. Accordingly, two major characteristics of the IMPS services are a presence service and an instant messaging service.

The presence service provides information, such as IMPS client presence and user presence. A client is a device program used to contact and obtain information from a program on another device. Typically, the device is linked to a network such as the Internet. The presence service also manages a list of registered users of the service. The instant messaging service allows transmission of an instant message comprising text, video, picture, sound or the like to a specific client or a user of another instant messaging system.

The IMPS system comprises a client loaded onto a specific device implementing an IMPS service and a server for connecting clients and sessions, such that presence information and instant message information are sent to a corresponding client. After the client undergoes a series of processes in order to use an instant messaging service and establishes a session with the server, the client enters a login state. At this time, the client requests a login from the server and acquires contact list information as well as presence information of each contact from the server.

Each time a related art IMPS client opens a session, the IMPS client opens a session through the above-described processes and enters a login state. Hence, when a session of the client is opened and power of a device loaded with the client is turned off and then turned on, the client re-opens a session through the above processes and receives information about the session from the server.

A problem occurs when the IMPS client is loaded onto a device such as a mobile terminal. Because the mobile terminal is slower than a general wired Internet in terms of data transmission speed, it takes a lengthy amount of time for a client in the corresponding terminal to re-open a session and log in again if the user turns off the mobile terminal power and then turns it back on.

### SUMMARY OF THE INVENTION

The present invention is directed to reestablishing a client session in a mobile terminal.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a method for reestablishing a client session in a mobile terminal, the method comprising loading a client program onto the mobile terminal for operating with a server, opening a session with the server, storing session information in a memory of the mobile terminal, and reopening the session with the server using the session information stored in the memory when the mobile terminal loses and regains power while the session is open.

In one aspect of the present invention, the method further comprises deleting the session information stored in the memory when the client program closes the session with the server.

In another aspect, reopening the session comprises determining whether the session information exists in the memory when the mobile terminal successively loses and regains power, determining whether the session is effective when the session information exists in the memory, and acquiring and updating presence information of contact lists from the server when the session is effective. Preferably, the client program reopens a session in the same way the client program opens a session with the server when the session information does not exist in the memory or when the session is not effective.

In a further aspect, the client program is an Instant Messaging and Presence Services (IMPS) client program. The memory is a nonvolatile memory. The session information includes at least one of a session ID, contact lists information and contacts information of entries in the contact lists.

In another embodiment of the present invention, a method for reestablishing a client session in a mobile terminal comprises loading a client program onto the mobile terminal for operating with a server, determining whether session information stored in a memory of the mobile terminal exists, determining whether a session with the server is effective when the session information exists, and receiving and updating presence information of contact lists from the server. The session information comprises at least one of a session ID, contact lists information and contacts information of entries in the contact lists.

In one aspect, the method further comprises deleting the session information stored in the memory when the client program closes the session with the server.

In another aspect, determining whether the session is effective comprises sending a KeepAliveRequest to the server and receiving a KeepAliveResponse comprising whether the session is effective or not.

In a further aspect, updating the presence information of the contact lists comprises sending a GetPresenceRequest to the server, receiving a GetPresenceResponse comprising the latest presence information of the contact lists from the server, and updating the presence information of the contact lists stored in the memory with the latest presence information.

Preferably, the method further comprises logging into the server when the session information exists in the memory, acquiring contact lists from the server, receiving information for entries of the contact lists, acquiring presence information of each of the entries, updating the client program's presence information, acquiring lists in which message exchange is blocked from the server, and storing acquired session information in the memory. The method may also comprise logging into the server when the session is effective.

Preferably, the client program is an Instant Messaging and Presence Services (IMPS) client program and the memory is a nonvolatile memory.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a flowchart illustrating a method for reestablishing an IMPS client session in a mobile terminal in accordance with one embodiment of the present invention.

FIG. 2 is a signal flowchart illustrating a method for reestablishing an IMPS client session in a mobile terminal in accordance with one embodiment of the present invention.

### DETAILED DESCRIPTION OF THE PREFERRED EMBODIMENTS

The present invention relates to reestablishing a client session in a mobile terminal of a wireless communication system. Reference will now be made in detail to the preferred embodiments of a method for reestablishing a client session in a mobile terminal in accordance with the present invention, examples of which are illustrated in the accompanying drawings.

In a preferred embodiment of the present invention, a client is a device program used to contact and obtain information from a program on another device. When a session of an IMPS client loaded onto a mobile terminal is opened, the IMPS client stores information of the session, such as presence information, in a memory of the mobile terminal. Then, when power of the mobile terminal is turned off and then turned on, the IMPS client checks whether the session is effective or not. If the session is effective, the IMPS client reestablishes the session by using the information stored in the memory. Preferably, the memory is a nonvolatile memory. Furthermore, session information stored in the nonvolatile memory comprises contact lists information, contacts information, a session ID for checking a session and the like.

Processes in which the IMPS client reestablishes the session by using the information stored in the memory are performed in such a manner that the IMPS client performs a “Keep Alive” transaction with the server. If it is determined that the previous session is effective, the IMPS client reopens the corresponding session and logs in again by updating the presence information stored in the memory.

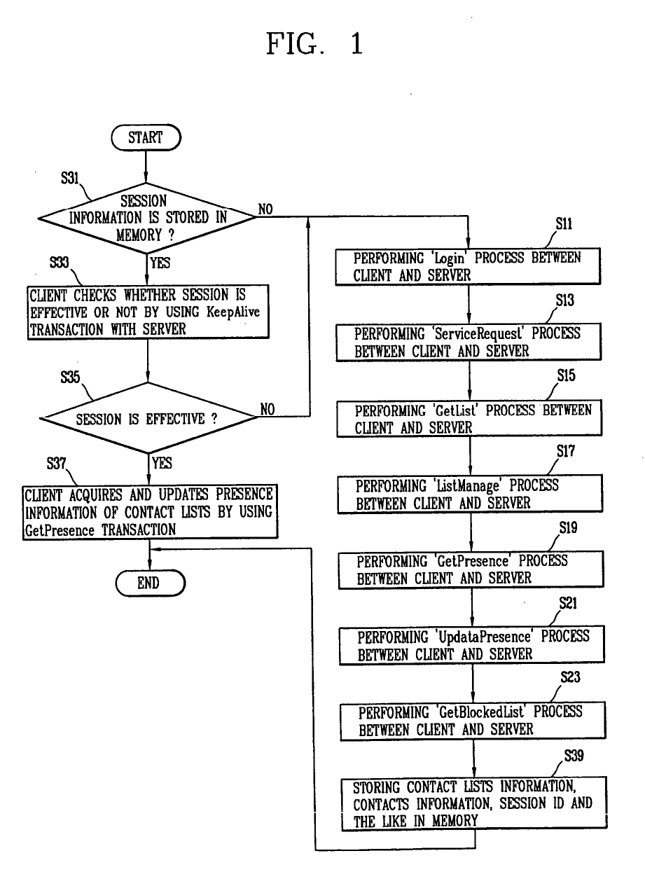

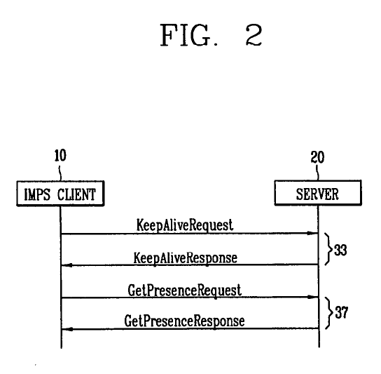

FIG. 1 is a flowchart illustrating an IMPS client session in a mobile terminal in accordance with one embodiment of the present invention. Referring to FIGS. 1 and 2, when implementing an instant messaging service through a predetermined mobile terminal, an IMPS client 10 of the terminal checks whether session information is stored in a memory (S31). At this time, the session information is previous session information (information for a previous session), and comprises contact lists information, contacts information, a session ID for checking a session and the like.

When the session information is stored in the memory, the IMPS client 10 checks whether a session with a server 20 is effective by performing a Keep Alive transaction with the server 20 by using a session ID from the session information (S33). Here, the Keep Alive transaction comprises a “KeepAliveRequest” which the IMPS client 10 sends to the server 20 and a “KeepAliveResponse” which the server 20 sends to the IMPS client 10 in response to the “KeepAliveRequest”.

When the session is effective (S35), the IMPS client 10 performs a “Get Presence” transaction with the server 20 and updates presence information for each entry in the contact lists to thereby open the session (S37). Hence, a session between the IMPS client 10 and the server 20 is opened by 1) determining whether the session between the IMPS client 10 and the server 20 is effective by using the session information stored in the memory of the mobile terminal; and 2) updating the presence information of the contact lists stored in the memory when the session is effective.

When the session information is not stored in the memory (S31), or when the session between the IMPS client 10 and the server 20, which is checked by the Keep Alive transaction is not effective (S35), the session is opened by receiving contact lists ID information and presence information of each contact from the server (S11 to S23). Preferably, the IMPS client 10 logs in to the server 20 by using a “LoginRequest” and a “LoginResponse” (S11), performs a “ServiceRequest” process between the IMPS client and the server through a “ServiceRequest” and a “ServiceResponse” (S13) and acquires a list about its own contact lists IDs through a “GetListRequest” and a “GetListResponse” (S15). After receiving the contact lists, the IMPS client 10 performs a “ListManage” process by using a “ListManageRequest” and a “ListManageResponse” (S17), acquires presence information from the server 20 by using a “GetPresenceRequest” and a “GetPresenceResponse” (S19), updates its own presence information by using an “UpdatePresenceRequest” and an “UpdatePresenceResponse” (S21) and then acquires a list of entities in which a message or invitation is blocked and opens a session by using a “GetBlockedListRequest” and a “GetBlockedListResponse” (S23).

When the session is successfully opened by the above-described method, the IMPS client 10 stores information regarding the contact lists, the presence information and the session ID, received through the “LoginResponse”, and the like in the memory of the mobile terminal (S39). Preferably, the memory is a nonvolatile memory in which stored information is not deleted when the power of the mobile terminal is turned off.

After successfully opening the session with the server, the IMPS client stores contact lists, presence information of each entry in the contact lists and a session ID in the memory. The IMPS client also deletes all session information stored in the memory when closing the session. However, when rebooting the power of the mobile terminal loaded with the IMPS client in a state that the session is open, the IMPS client preserves the session information stored in the memory and reopens the session with the server by using the preserved session information. Thus, the need for acquiring corresponding session information for reopening the session upon reboot can be omitted.

FIG. 2 is a signal flowchart illustrating a method for reestablishing an IMPS client session in accordance with one embodiment of the present invention. Referring to FIG. 2, it is assumed that session information is stored in a memory of a mobile terminal and power of the mobile terminal is rebooted in a state that the session is open.

The IMPS client 10 sends a “KeepAliveRequest” to the server 20 by using a session ID from the session information stored in the memory to check the effectiveness of the session with the server 20. The IMPS client 10 receives a “KeepAliveResponse” from the server 20 comprising a response to the “KeepAliveRequest” (S33).

If a value of the “KeepAliveResponse” is “successful,” the session is effective. Accordingly, the IMPS client 10 sends a “GetPresenceRequest” to the server 20. In response, the IMPS client 10 receives a “GetPresenceResponse” from the server 20, wherein the “GetPresenceResponse” comprises presence information regarding the contact lists stored in the memory to thereby update the presence information of the contact lists (S37).

When the value of the “KeepAliveResponse” is an error such as “Session Expired” or “Not Logged In,” a power-off state of the mobile terminal is long. Thus, the server 20 considers that the IMPS client 10 is logged out from the session. At this time, since the session information stored in the memory of the mobile terminal cannot be used in session establishment, the IMPS client 10 establishes a session in accordance with steps S11-S23 and S39, as illustrated in FIG. 1.

A method for reestablishing a session in accordance with the present invention will now be described. When a user implements an instant messaging service with a mobile terminal which does not store session information in a memory, the IMPS client 10 loaded onto the mobile terminal establishes a session with the server 20 by performing a “Login” process, a “ServiceRequest” process, a “GetList” process, a “ListManage” process, a “GetPresence” process, an “UpdatePresence” process and a “GetBlockedList” process in turn. Then, the IMPS client 10 loaded onto the mobile terminal stores in a nonvolatile memory of the terminal a session ID, contact lists information and contacts information retrieved from the information received from the server 20.

The user may then turn the power of the mobile terminal off during a state when the session is open to perform a terminal-related operation. For example, the user may turn the power off to change the mobile terminal's battery. Upon completion of the operation the power of the mobile terminal is turned back on.

When the power is turned on, the IMPS client 10 of the mobile terminal extracts the session ID from the session information stored in the memory, sends a “KeepAliveRequest” to the server 20 and receives a “KeepAliveResponse” from the server 20, whereby the IMPS client 10 checks whether the session is effective or not. Methods for opening a session between the IMPS client 10 and the server 20 vary according to whether the session is effective or not.

When the “KeepAliveResponse” comprises a “successful” value, the IMPS client 10 sends a “GetPresenceRequest” to the server 20 and receives a “GetPresenceResponse” in response to the “GetPresenceRequest”, whereby the IMPS client 10 updates the presence information of the contact lists stored in the memory. Preferably, when the “KeepAliveResponse” comprises the “successful” value, the session before rebooting the power of the mobile terminal is still effective.

After the session between the IMPS client 10 and the server 20 is successfully opened by updating the presence information, the IMPS client 10 determines whether session information has been changed by the user. If there is changed information, the IMPS client 10 updates/stores only the changed session information in the memory. Preferably, the IMPS client 10 can selectively update/store only the changed session information or update/store all session information. However, when the “KeepAliveResponse” comprises an “error” value, the IMPS client 10 determines that the session is expired and performs all processes of establishing a session as shown in steps S11-S23 and S39 of FIG. 1.

The method for reestablishing a session in accordance with the present invention can be applied when the IMPS client stores session information in the memory and then reboots the power of the mobile terminal in a state when the IMPS client is not logged out from the session. When the user closes (logs out from) the session, the session information stored in the memory is deleted. Thus, in order to reopen the session after rebooting the power of the mobile terminal, all the processes of establishing a session should be performed.

In the method of reestablishing a session in accordance with the present invention, a “Login” process, a “ServiceRequest” process, a “GetList” process, a “ListManage” process, a “GetPresence” process, an “UpdatePresence” process and a “GetBlockedList” process do not have to be performed.

Accordingly, the method of reestablishing an IMPS client session in a mobile terminal in accordance with the present invention simplifies the process of opening a session when a previous session is effective. This reduces the time for reestablishing the session such that the convenience of mobile terminals for users having low transmission speed is enhanced.

In addition, the method of reestablishing an IMPS client session in a mobile terminal in accordance with the present invention reduces traffic by inhibiting unnecessary data transmission and efficiently using radio resources because a session may be reestablished by simplifying the process of opening a session.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A method for reestablishing a client session in a mobile terminal, the method comprising:
loading a client program onto the mobile terminal for operating with a server;
opening a session with the server;
storing session information in a memory of the mobile terminal; and
reopening the session with the server using the session information stored in the memory when the mobile terminal loses and regains power while the session is open.

2. The method of claim 1, further comprising:
deleting the session information stored in the memory when the client program closes the session with the server.

3. The method of claim 1, wherein reopening the session comprises:
determining whether the session information exists in the memory when the mobile terminal loses and regains power;
determining whether the session is effective when the session information exists in the memory; and
acquiring and updating presence information of contact lists from the server when the session is effective.

4. The method of claim 3, wherein the client program reopens a session in the same way the client program opens a session with the server when the session information does not exist in the memory.

5. The method of claim 3, wherein the client program reopens a session in the same way the client program opens a session with the server when the session is not effective.

6. The method of claim 1, wherein the client program is an Instant Messaging and Presence Services (IMPS) client program.

7. The method of claim 1, wherein the memory is a nonvolatile memory.

8. The method of claim 1, wherein the session information includes at least one of a session ID, contact lists information and contacts information of entries in the contact lists.

9. A method for reestablishing a client session in a mobile terminal, the method comprising:
loading a client program onto the mobile terminal for operating with a server;
determining whether session information stored in a memory of the mobile terminal exists;
determining whether a session with the server is effective when the session information exists; and
receiving and updating presence information of contact lists from the server.

10. The method of claim 9, wherein the session information comprises at least one of a session ID, contact lists information and contacts information of entries in the contact lists.

11. The method of claim 9, further comprising:
deleting the session information stored in the memory when the client program closes the session with the server.

12. The method of claim 9, wherein determining whether the session is effective comprises:
sending a KeepAliveRequest to the server; and
receiving a KeepAliveResponse comprising whether the session is effective or not.

13. The method of claim 9, wherein updating the presence information of the contact lists comprises:
sending a GetPresenceRequest to the server;
receiving a GetPresenceResponse comprising the latest presence information of the contact lists from the server; and
updating the presence information of the contact lists stored in the memory with the latest presence information.

14. The method of claim 9, further comprising:
logging into the server when the session information exists in the memory;
acquiring contact lists from the server;
receiving information for entries of the contact lists;
acquiring presence information of each of the entries;
updating the client program's presence information;
acquiring lists in which message exchange is blocked from the server; and
storing acquired session information in the memory.

15. The method of claim 14, further comprising logging into the server when the session is effective.

16. The method of claim 9, wherein the client program is an Instant Messaging and Presence Services (IMPS) client program.

17. The method of claim 9, wherein the memory is a nonvolatile memory.
